(19) United States
(12) Patent Application Publication
(10) Pub. No.: US 2013/0246012 A1
(43) Pub. Date: Sep. 19, 2013

(54) CALCULATION APPARATUS, COMPUTER-READABLE RECORDING MEDIUM, AND CALCULATION METHOD

(71) Applicant: FUJITSU LIMITED, Kawasaki-shi (JP)

(72) Inventors: Koji DEMIZU, Atsugi (JP); Masayuki Kidera, Kawasaki (JP); Yukihiko Furumoto, Kawasaki-shi (JP); Ryusuke Akahoshi, Machida (JP); Mari Morimoto, Kawasaki (JP)

(73) Assignee: FUJITSU LIMITED, Kawasaki-shi (JP)

(21) Appl. No.: 13/743,058

(22) Filed: Jan. 16, 2013

(30) Foreign Application Priority Data
Mar. 19, 2012 (JP) 2012-062771

(51) Int. Cl. G06F 17/50

(52) U.S. Cl. CPC G06F 17/50
USPC 703/1

(57) ABSTRACT

A calculation apparatus includes a memory and a processor coupled to the memory. The processor executes a process including specifying a region in which a second model including a predetermined surface of a first model interferes with the first model. The processor executes the process including specifying a displacement point of the second model when deformed. The processor executes the process including calculating a physical property value related to deformation of the first model. The processor executes the process including calculating an attitude of the second model in the case where the second model is deformed such that a position of the displacement point is in a position of the first model after deformation.

### CROSS-REFERENCE TO RELATED APPLICATIONS

This application is based upon and claims the benefit of priority of the prior Japanese Patent Application No. 2012-062771, filed on Mar. 19, 2012, the entire contents of which are incorporated herein by reference.

### FIELD

The embodiments discussed herein are directed to a calculation apparatus, a calculation program, and a calculation method.

### BACKGROUND

There has been a technology of developing a product such as a mechanical product by using a three-dimensional CAD (Computer Aided Design). The shape of a product is defined in the three-dimensional CAD for product modeling. The shape of the product being defined, the three-dimensional CAD is suitable for presenting an assembled state of a static product model in which a component model configuring the product model stands still. However, there are cases where the three-dimensional CAD is not considered suitable for presenting the assembled state of a dynamic product model in which the component model configuring the product model is moved to assemble the product model. This is because the shape of a component is defined, making it difficult for the three-dimensional CAD to accommodate to the deformation of the component model that occurs when the dynamic product model is assembled.

For this reason, a note, an icon or the like is displayed when the three-dimensional CAD is used to deform the component model of a resin component, a label or the like and present the assembled state of the dynamic product model, the note or the icon having a message described therein, in a predetermined language, that the component is deformed for assembly. In this manner, a user can comprehend that the component is deformed for assembly. However, the user does not always understand the language used in the note or the icon. For example, a user who does not understand Japanese would not be able to understand what the note or the icon written in Japanese indicates. In this way, different users understand different languages. It is thus difficult for all the users to understand what the note or the icon indicates by the display of the note, the icon or the like.

Now, there is a technology in which a physical property value of the component model as well as a boundary condition, which is the information on which part of the component model is fixed when deforming the component model and the like, are set by the user to perform analysis using the physical property value and the boundary condition and simulate the deformation of the component model. By such simulation, information related to the component model after deformation, such as a position and an attitude of each surface of the component model after deformation, can be obtained.
Patent Document 1: Japanese Laid-open Patent Publication No. 2004-280314
Patent Document 2: Japanese Laid-open Patent Publication No. 2008-287300

However, there is a problem in the above technology of simulating the deformation of the component model in that the information related to the model after deformation cannot be obtained easily.

For example, in the technology of simulating the deformation of the component model, the user sets the physical property value and the boundary condition of the component model when performing simulation, which is cumbersome for the user. Therefore, in the technology of simulating the deformation of the component model, there exists the problem that the information related to the model after deformation cannot be obtained easily. Such problem arises not only in the three-dimensional CAD but also in a DMU (Digital Mock Up), for example, in a similar manner.

### SUMMARY

According to an aspect of an embodiment, a calculation apparatus includes a memory and a processor coupled to the memory. The processor executes a process including specifying a region in which a second model including a predetermined surface of a first model interferes with the first model, specifying a displacement point of the second model when deformed, on the basis of a position in the second model of the region specified, calculating a physical property value related to deformation of the first model on the basis of a first distance from a predetermined position of the region projected onto a surface of the second model corresponding to the predetermined surface to the displacement point, and a second distance from the predetermined surface to a surface of the first model facing the predetermined surface, and calculating an attitude of the second model in the case where the second model is deformed such that a position of the displacement point is in a position of the first model after deformation, on the basis of the physical property value calculated and the position of the first model after deformation when deforming the first model.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a functional configuration of a calculation apparatus according to Example;

FIG. 2 is a diagram for describing an example of a process performed by the calculation apparatus according to Example;

FIG. 3 is a diagram for describing an example of a process performed by the calculation apparatus according to Example;

FIG. 4 is a diagram for describing an example of a process performed by the calculation apparatus according to Example;

FIG. 5 is a diagram for describing an example of a process performed by the calculation apparatus according to Example;

FIG. 6 is a table illustrating an example of a data structure of animation information;

FIG. 7 is a table illustrating an example of a data structure of deformation information;

FIG. 8 is a table illustrating an example of a data structure of move information;

FIG. 9 is a diagram illustrating an example of an instruction acceptance screen;

FIG. 10 is a diagram for describing an example of a process performed by the calculation apparatus according to Example;

FIG. 11 is a diagram for describing an example of a process performed by the calculation apparatus according to Example;

FIG. 12 is a diagram for describing an example of a process performed by the calculation apparatus according to Example;

FIG. 13 is a diagram illustrating an example of a bounding box generated by a first specification unit;

FIG. 14 is a diagram for describing an example of a process performed by the calculation apparatus according to Example;

FIG. 15 is a diagram for describing an example of a process performed by the calculation apparatus according to Example;

FIG. 16 is a diagram for describing an example of a process performed by the calculation apparatus according to Example;

FIG. 17 is a diagram for describing an example of a process performed by the calculation apparatus according to Example;

FIG. 18 is a diagram for describing an example of a process performed by the calculation apparatus according to Example;

FIG. 19 is a diagram for describing that the shape of a deformation standard model would be different when deformed depending on the magnitude of a physical property value K;

FIG. 20 is a diagram for describing that the shape of the deformation standard model would be different when deformed depending on the magnitude of the physical property value K;

FIG. 21 is a diagram illustrating an example of a shape of the deformation standard model after deformation;

FIG. 22 is a diagram illustrating an example of a case where a model of the bounding box is deformed;

FIG. 23 is a diagram for describing FFD;

FIG. 24 is a flowchart illustrating steps of a calculation process according to Example;

FIG. 25 is a flowchart illustrating steps of a deformation process according to Example;

FIG. 26 is a flowchart illustrating steps of the deformation process according to Example; and

FIG. 27 is a diagram illustrating a computer that executes a calculation program.

### DESCRIPTION OF EMBODIMENTS

Preferred embodiments of the present invention will be explained with reference to accompanying drawings. Note that Example is not to limit the disclosed technology.

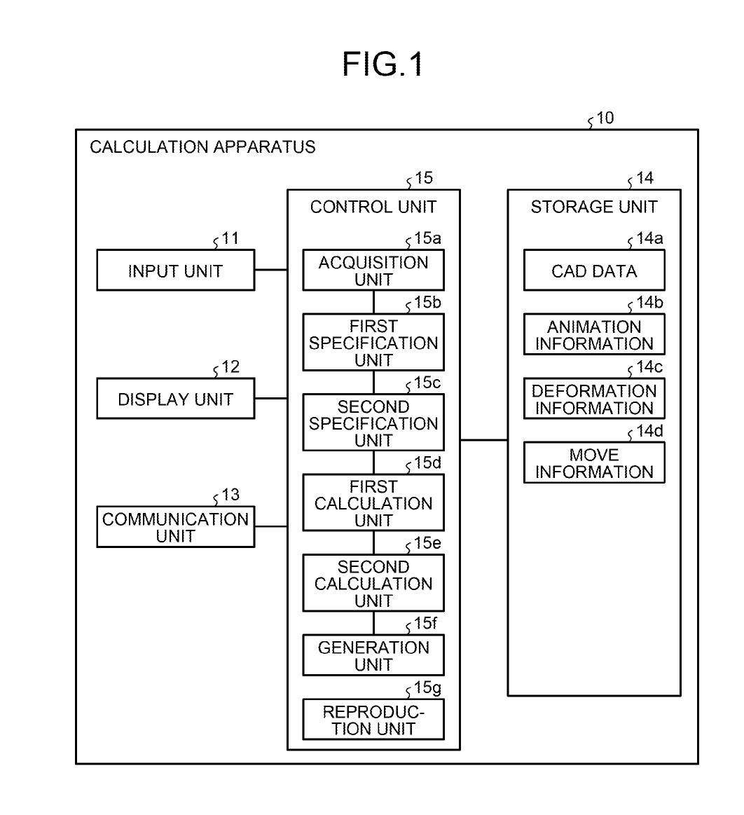

A calculation apparatus according to Example will be described. FIG. 1 is a diagram illustrating an example of a functional configuration of the calculation apparatus according to Example.

Functional Configuration of Calculation Apparatus

As illustrated in FIG. 1, a calculation apparatus 10 includes an input unit 11, a display unit 12, a communication unit 13, a storage unit 14, and a control unit 15.

The input unit 11 inputs various pieces of information. The input unit 11 is also used for designating and selecting the various pieces of information. For example, the input unit 11 accepts from a user an instruction to execute a calculation process to be described and inputs the accepted instruction to the control unit 15.

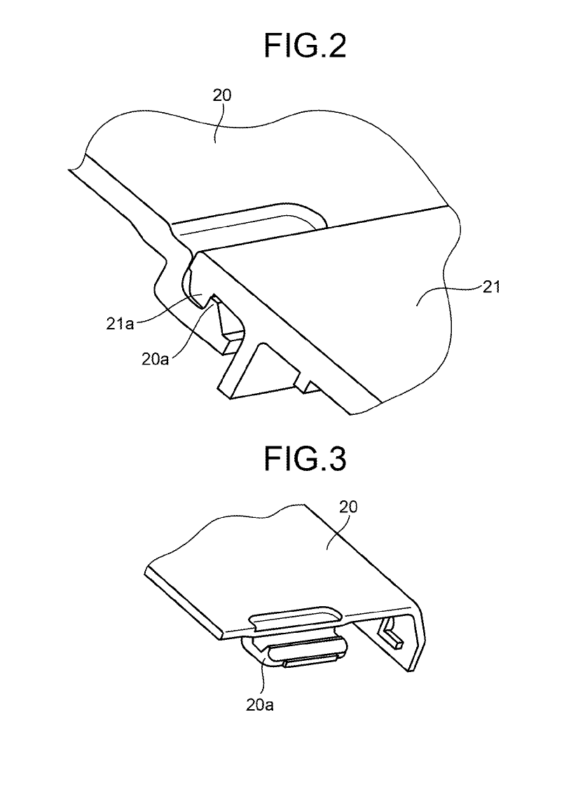

Moreover, the input unit 11 designates, by the operation of the user, a component model that is to be deformed (a component model to be deformed) or a component model that is to be moved (a component model to be moved) among the component models displayed on the display unit 12. A case where the input unit 11 includes a mouse as a pointing device will be described. FIGS. 2 and 3 are diagrams for describing an example of a process performed by the calculation apparatus according to Example. The example in FIG. 2 illustrates an example of a cross-sectional view of a component model of a mobile phone casing represented by three-dimensional CAD data displayed on the display unit 12. The example in FIG. 2 illustrates a part of the cross-sectional view of the component model. In the example illustrated in FIG. 2, the display unit 12 displays a case where a claw 20a of a component model 20 and a claw 21a of a component model 21 of the mobile phone casing are fitted together. As illustrated in the example in FIG. 2, a case where the display unit 12 displays the component model 20 and the component model 21 will be described. In this case, the component model 20 is selected and displayed on the display unit 12 as illustrated in FIG. 3, when the user operates the mouse to hover a cursor (not illustrated) displayed on the display unit 12 over the component model 20 and clicks the mouse. The model to be deformed or moved is selected in this manner.

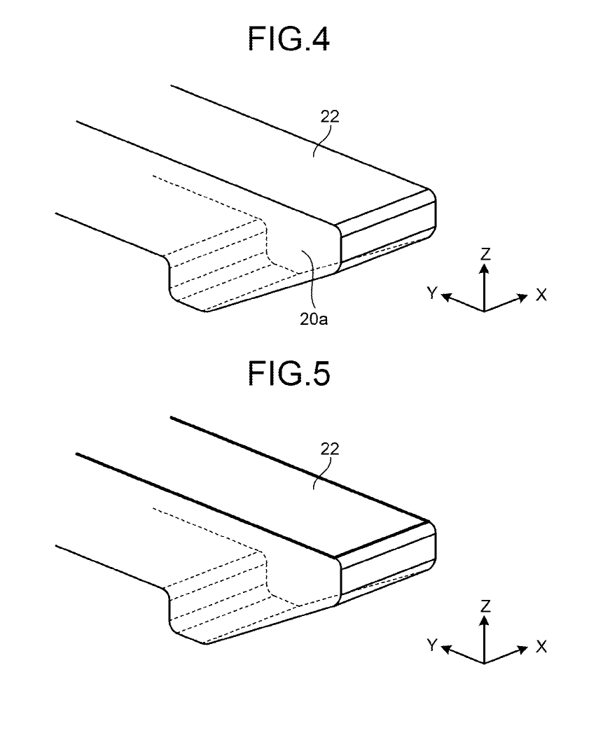

Moreover, the input unit 11 designates, by the operation of the user, a surface to be deformed (a deformation surface) from among surfaces of the component model to be deformed or moved that is displayed on the display unit 12. FIGS. 4 and 5 are diagrams for describing an example of a process performed by the calculation apparatus according to Example. The example in FIG. 4 illustrates a case where the claw 20a of the component model 20 in the previous example of FIG. 3 is displayed on the display unit 12. Note that the claw 20a illustrated by the example in FIG. 4 is oriented upside down from the claw 20a of the example in FIG. 3. In the example of FIG. 4, a surface 22 is designated and selected as illustrated in the example of FIG. 5, when the user operates the mouse to hover the cursor displayed on the display unit 12 over the surface 22 among a plurality of surfaces of the claw 20a and clicks the mouse.

Moreover, the input unit 11 accepts, by the operation of the user, three-dimensional coordinates (x, y, z) that indicate the position of the component model after deformation, the component model being displayed on the display unit 12. Here, the “position after deformation” indicates a target position to which the user intends to deform the component model to be deformed. For example, the three-dimensional coordinates indicating the position of the component model after deformation are designated when the user operates the mouse to hover the cursor displayed on the display unit 12 over the position of the component model after deformation and clicks the mouse.

An example of a device for the input unit 11 includes a device such as the mouse and a keyboard that receive operation by the user.

The display unit 12 displays various images. For example, the display unit 12 displays the component model represented by CAD data 14a to be described in a manner selectable by the user. In addition, the display unit 12 displays the deformation surface of the component model to be deformed that is selected by the user in a manner that the deformation surface can be designated. An example of a device for the display unit 12 includes a liquid crystal display.

The communication unit 13 is an interface for performing communication among devices and is connected to a server that is not illustrated, for example. An example of such server includes a server that reproduces animation data. The communication unit 13 receives animation information 14b, deformation information 14c, and move information 14d transmitted from a reproduction unit 15g to be described and transmits the animation information 14b, the deformation information 14c, and the move information 14d that are received to the server. The server then reproduces an animation of the component model by using the animation information 14b, the deformation information 14c, and the move information 14d.

The storage unit 14 stores various pieces of information such as the CAD data 14a, the animation information 14b, the deformation information 14c, and the move information 14d.

The CAD data 14a is a piece of data representing the three-dimensional component model. For example, the CAD data 14a includes an ID (Identification) for identifying each of the plurality of component models, an ID for identifying each surface of the plurality of component models, and three-dimensional coordinates for a vertex of each surface for identifying the area of each surface.

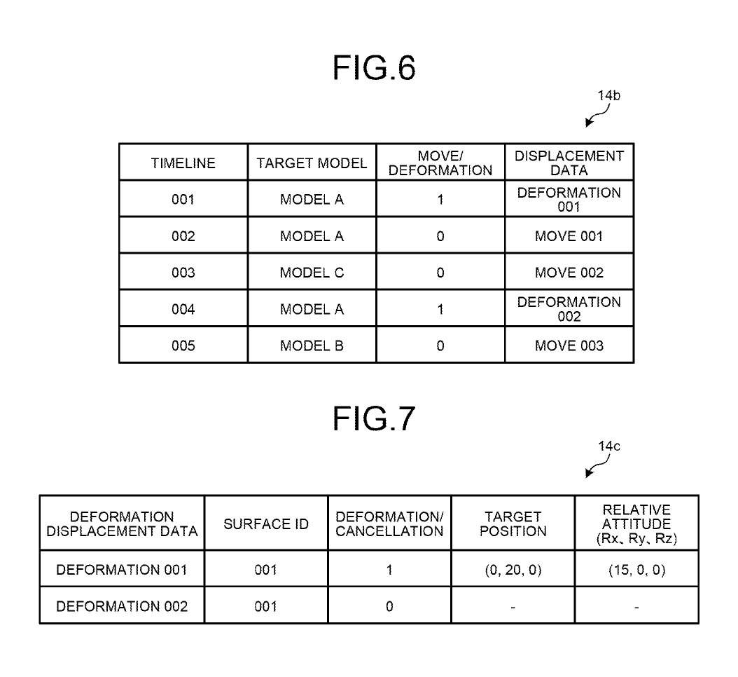

The animation information 14b is a piece of information representing the animation. The animation information 14b is generated by a generation unit 15f to be described and stored in the storage unit 14. FIG. 6 is a table illustrating an example of a data structure of the animation information. In the example of FIG. 6, a record in the animation information 14b includes items respectively named a “timeline”, a “target model”, a “move/deformation”, and a “displacement data”. The order of reproducing the animation is registered under the item “timeline”. The ID of the component model to be reproduced is registered under the item “target model”. A value indicating the reproduction of the animation in which the component model is moved, or a value indicating the reproduction of the animation in which the component model is deformed, is set under the item “move/deformation”. The example in FIG. 6 illustrates a case where “0” is set as the value indicating the reproduction of the animation in which the component model is moved. In addition, the example in FIG. 6 illustrates a case where “1” is set as the value indicating the reproduction of the animation in which the component model is deformed. Registered under the item “displacement data” is an ID for identifying data related to the move or deformation of the component model in the animations displayed in the order registered under the item “timeline”. This ID would be the key information for retrieving information from the deformation information 14c and the move information 14d to be described, the information including the move amount of the component model when moved and the position after deformation of the component model when deformed.

The deformation information 14c is a piece of information indicating the position and an attitude of the component model after deformation. The deformation information 14c is generated by the generation unit 15f and stored in the storage unit 14. FIG. 7 is a table illustrating an example of a data structure of the deformation information. In the example of FIG. 7, a record in the deformation information 14c includes items respectively named a “deformation displacement data”, a “surface ID”, a “deformation/cancellation”, a “target position”, and a “relative attitude (Rx, Ry, Rz)”. The ID for identifying the data related to the deformation of the component model in the animation is registered under the item “deformation displacement data”. Registered under the item “surface ID” is an ID of a surface to be deformed or a surface the deformation of which is to be cancelled, the surface being designated by the operation of the input unit 11 by the user. A value indicating the deformation of the component model, or a value indicating the cancellation of the deformation of the component model, namely, the restoration of the component model to the shape before deformation, is set under the item “deformation/cancellation”. The example in FIG. 7 illustrates a case where “1” is set as the value indicating the deformation of the component model. In addition, the example in FIG. 7 illustrates a case where “0” is set as the value indicating the cancellation of the deformation of the component model. Registered under the item “target position” are the three-dimensional coordinates being designated by the operation of the input unit 11 by the user and indicating the position of the component model after deformation. Registered under the item “relative attitude (Rx, Ry, Rz)” is the amount indicating the variation in the attitude of the surface indicated by the ID registered under the “surface ID” after deformation with respect to the attitude before deformation, when the component model is deformed. Such amount includes the amount of rotation around each axis (a rotation amount around an X-axis Rx, a rotation amount around a Y-axis Ry, and a rotation amount around a Z-axis Rz).

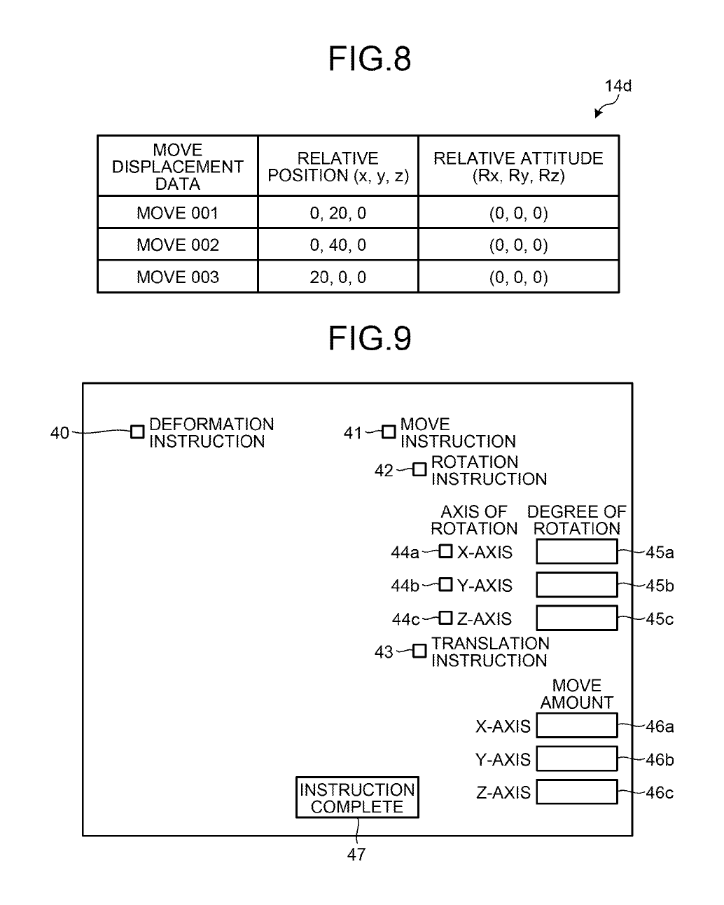

The move information 14d is a piece of information indicating the position and the attitude of the component model after being moved. The move information 14d is generated by the generation unit 15f and stored in the storage unit 14. FIG. 8 is a table illustrating an example of a data structure of the move information. In the example of FIG. 8, a record in the move information 14d includes items respectively named a “move displacement data”, a “relative position (x, y, z)”, and the “relative attitude (Rx, Ry, Rz)”. The ID for identifying the data related to the move of the component model in the animation is registered under the item “move displacement data”. Registered under the item “relative position (x, y, z)” is the information indicating how much the component model is moved from the position before to the position after the component model is moved. Such information includes a three-dimensional vector (x, y, z). Registered under the item “relative attitude (Rx, Ry, Rz)” is the amount indicating the variation in the attitude of the component model after move with respect to the attitude of the component model before move, when the component model is deformed. Such amount includes the amount of rotation around each axis (the rotation amount around the X-axis Rx, the rotation amount around the Y-axis Ry, and the rotation amount around the Z-axis Rz before deformation).

The storage unit 14 is a semiconductor memory device such as a flash memory or a storage device such as a hard disk (HDD) and an optical disk, for example. The storage unit 14 is not limited to the storage devices of the aforementioned types but may also be a RAM (Random Access Memory) or a ROM (Read Only Memory).

The control unit 15 includes an internal memory for storing therein a program and control data that define various procedures to execute various processes. As illustrated in FIG. 1, the control unit 15 includes an acquisition unit 15a, a first specification unit 15b, a second specification unit 15c, a first calculation unit 15d, a second calculation unit 15e, the generation unit 15f, and the reproduction unit 15g.

The acquisition unit 15a acquires various pieces of information. Specifically, the acquisition unit 15a first acquires the CAD data 14a from the storage unit 14 and controls the display on the display unit 12 so that the plurality of component models of a product represented by the acquired CAD data 14a is displayed. As a result, the plurality of component models is displayed on the display unit 12 such that the component model to be deformed can be designated by the user. For example, as illustrated in the previous example in FIG. 2, the acquisition unit 15a controls the display of the display unit 12 so as to display the component model 20 and the component model 21 thereon. Subsequently, the acquisition unit 15a determines whether or not the user has designated the component model to be deformed or moved by operating the input unit 11.

The acquisition unit 15a performs the following process when the component model to be deformed or moved is designated. That is, the acquisition unit 15a controls the display on the display unit 12 such that a screen for accepting a move instruction for moving the component model to be moved and a deformation instruction for deforming the component model to be deformed is displayed. Such screen will be noted as an “instruction acceptance screen” in the description below.

FIG. 9 is a diagram illustrating an example of the instruction acceptance screen. The instruction acceptance screen illustrated in the example of FIG. 9 includes a check box 40 for accepting the deformation instruction and a check box 41 for accepting the move instruction. The instruction acceptance screen illustrated in the example of FIG. 9 also includes a check box 42 which will be available for checking to accept a rotation instruction when the check box 41 is checked off, namely, when the move instruction is designated. Moreover, the instruction acceptance screen illustrated in the example of FIG. 9 includes a check box 43 which will be available for checking to accept a translation instruction when the move instruction is designated. Moreover, the instruction acceptance screen illustrated in the example of FIG. 9 includes check boxes 44a to 44c which will be available for checking to designate an axis around which the component model will be rotated when the check box 42 is checked off, namely, when the rotation instruction is designated. In the example of FIG. 9, the check box 44a is provided for designating an X-axis as the axis around which the component model will be rotated. Also, in the example of FIG. 9, the check box 44b is provided for designating a Y-axis as the axis around which the component model will be rotated. Moreover, in the example of FIG. 9, the check box 44c is provided for designating a Z-axis as the axis around which the component model will be rotated.

In addition, the instruction acceptance screen illustrated in the example of FIG. 9 includes a text box 45a which will be writable when the check box 44a is checked off, namely, when the X-axis is designated as the axis around which the component model will be rotated. Also, the instruction acceptance screen illustrated in the example of FIG. 9 includes a text box 45b which will be writable when the check box 44b is checked off, namely, when the Y-axis is designated as the axis around which the component model will be rotated. Moreover, the instruction acceptance screen illustrated in the example of FIG. 9 includes a text box 45c which will be writable when the check box 44c is checked off, namely, when the Z-axis is designated as the axis around which the component model will be rotated. In the example of FIG. 9, the move amount of the component model, when it is rotated around the X-axis, is set in the text box 45a by the user by a degree value. Also, in the example of FIG. 9, the move amount of the component model, when it is rotated around the Y-axis, is set in the text box 45b by the user by a degree value. Moreover, in the example of FIG. 9, the move amount of the component model, when it is rotated around the Z-axis, is set in the text box 45c by the user by a degree value.

Furthermore, the instruction acceptance screen illustrated in the example of FIG. 9 includes text boxes 46a to 46c which will be writable when the check box 43 is checked off, namely, when the translation instruction is designated. In the example of FIG. 9, the move amount of the component model in the X-axis direction, when it is moved translationally, is set in the text box 46a by the user. Also, in the example of FIG. 9, the move amount of the component model in the Y-axis direction, when it is moved translationally, is set in the text box 46b by the user. Moreover, in the example of FIG. 9, the move amount of the component model in the Z-axis direction, when it is moved translationally, is set in the text box 46c by the user.

In the example of FIG. 9, the user operates the mouse to click on an instruction complete button 47 when the user has performed designating the deformation instruction or the move instruction and the rotation instruction, the translation instruction, the axis of rotation, setting of the degree of rotation, setting of the move amount, and the like. Consequently, the instruction acceptance screen will be closed, and the designation and the setting of the various information will be completed.

Furthermore, the acquisition unit 15a controls the display on the display unit 12 so as to display a screen for accepting an instruction of whether to complete or continue generating the animation, when information related to deformation to be described or information related to move to be described is recorded by the generation unit 15f. When the instruction to continue generating the animation is accepted, the acquisition unit 15a reacquires the CAD data 14a from the storage unit 14 and controls the display on the display unit 12 such that the plurality of component models to be deformed or moved is displayed for the user to designate.

With respect to the component model for which the deformation instruction has been designated by the user, the first specification unit 15b specifies an interference region where the component model interferes with a model of a bounding box, an outer side surface of which abuts on the deformation surface to be described of the component model. A specific example will be given in the description below. Note that the description will be made with an example where the deformation instruction has been designated by the user for the previous component model 20. For example, the first specification unit 15b first controls the display on the display unit 12 to display the component model 20 for which the deformation instruction has been designated. For example, the first specification unit 15b controls the display on the display unit 12 to display the component model 20 as illustrated in the previous example of FIG. 3.

Then, the first specification unit 15b controls the display on the display unit 12 to display a message for designating the surface to be deformed (the deformation surface) from among the respective surfaces of the component model 20 for which the deformation instruction has been designated, the message saying, for example, “Designate a deformation surface”. This would prompt the user to designate the deformation surface from among the respective surfaces of the component model 20. Note that the description will be given with an example where the aforementioned deformation surface 22 has been designated by the user.

The first specification unit 15b performs the following process when the deformation surface 22 is designated by the user. That is, the first specification unit 15b controls the display on the display unit 12 so as to display a message for designating the three-dimensional coordinates (x, y, z) indicating the position of the component model 20 after deformation, the message saying, for example, “Hover the cursor over the position of the component model after deformation and click”. As a result, the three-dimensional coordinates (x, y, z) indicating the position after deformation of the component model 20 displayed on the display unit 12 is designated by the operation of the user.

When the three-dimensional coordinates (x, y, z) indicating the position of the component model 20 after deformation is designated by the user, the first specification unit 15b projects the deformation surface 22 onto each of a Y-Z plane, an X-Z plane, and an X-Y plane. The Y-Z plane, the X-Z plane, and the X-Y plane will be noted as an X plane, a Y plane, and a Z plane, respectively, in the description below.

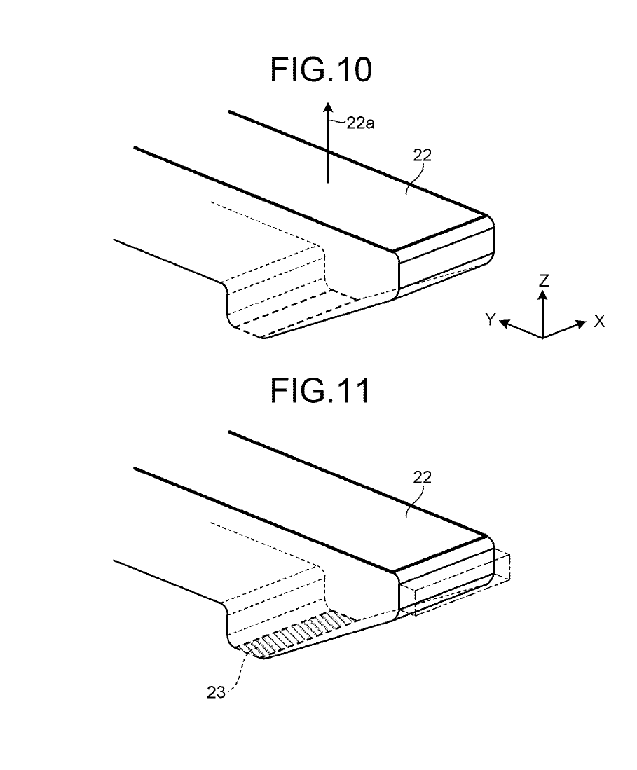

Then, the first specification unit 15b specifies one region having the maximum area among the regions of the deformation surface 22 projected onto each of the X plane, the Y plane, and the Z plane, and specifies the direction of a normal vector of the plane onto which the specified region has been projected as the direction into which the deformation surface 22 is to be deformed. FIG. 10 is a diagram for describing an example of a process performed by the calculation apparatus according to Example. For example, when the aforementioned deformation surface 22 is projected onto each of the X plane, the Y plane, and the Z plane, the Z plane would have the maximum area of the projected region. Therefore, as illustrated in the example of FIG. 10, the first specification unit 15b specifies the direction of a normal vector 22a of the Z plane as the direction into which the deformation surface 22 is to be deformed. Although a typical normal vector has two directions on one plane, the first specification unit 15b according to the present Example specifies the direction that is directed outward from the component model, not the direction inward to the component model, as the direction of the normal vector.

Subsequently, the first specification unit 15b searches for a surface of the component model 20 that is present in the direction opposite from the specified direction of the normal vector, and specifies a surface farthest away from the deformation surface 22 as a surface on the back side of the deformation surface 22 (a back surface). FIG. 11 is a diagram for describing an example of a process performed by the calculation apparatus according to Example. In the example of FIG. 11, the component model 20 includes a back surface 23 on the surface on the back side of the deformation surface 22. In the example of FIG. 11, the first specification unit 15b specifies the back surface 23 as the surface on the back side of the deformation surface 22.

Then, the first specification unit 15b determines whether or not there is a surface that has not been selected among the surfaces connected to the deformation surface 22. When there is a surface that has not been selected, the first specification unit 15b selects one surface that has not been selected among the surfaces connected to the deformation surface 22. When there is no surface that has not been selected, the first specification unit 15b selects one surface that is connected to the surface having already been selected but that has not been selected. Then, the first specification unit 15b projects the selected surface onto each of the X plane, the Y plane, and the Z plane. The first specification unit 15b then determines whether or not the direction of the normal vector of the plane onto which the region with the maximum area is projected has the following direction, the region being one of the regions of the surface that is projected onto each of the X plane, the Y plane, and the Z plane. That is, the first specification unit 15b determines whether or not such direction of the normal vector is different from any of: the direction into which the deformation surface 22 is to be deformed; the direction of the normal vector of the back surface 23; and the direction of the normal vector of an “extracted surface” to be described when there is the “extracted surface”.

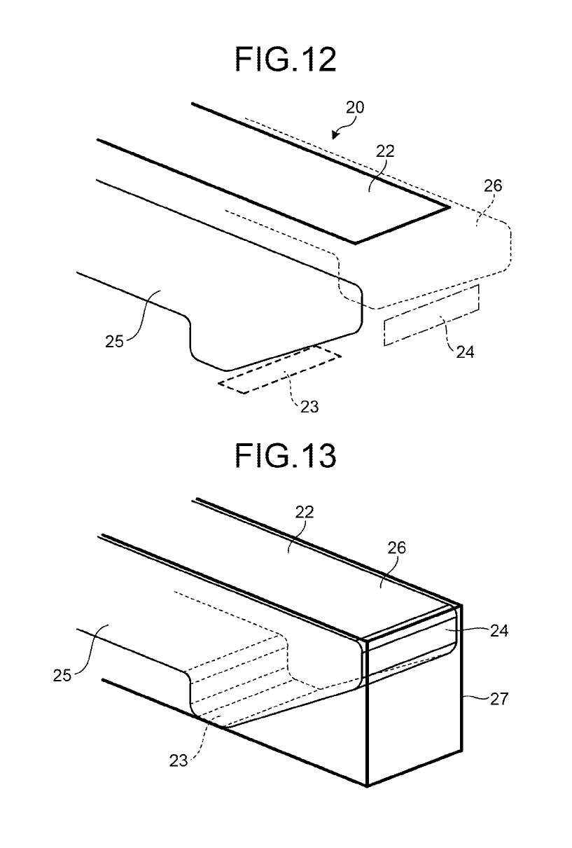

When such direction of the normal vector is different from any of the directions, the first specification unit 15b extracts the selected surface. Such surface is the aforementioned “extracted surface”. The first specification unit 15b repeats the following process until four surfaces are extracted, the four surfaces having the normal vectors in four directions other than the direction into which the deformation surface 22 is to be deformed and the direction of the normal vector of the back surface 23, among six directions including a positive and a negative directions for each of the X, the Y, and the Z axes. That is, the first specification unit 15b selects one surface that has not been selected to repeatedly perform the aforementioned process on the selected surface. FIG. 12 is a diagram for describing an example of a process performed by the calculation apparatus according to Example. The example of FIG. 12 illustrates three surfaces 24, 25, and 26 among the four surfaces having the normal vectors in the four directions other than the direction into which the deformation surface 22 is to be deformed and the direction of the normal vector of the back surface 23. The first specification unit 15b extracts the four surfaces including the surfaces 24, 25, and 26 and a surface (not illustrated) facing the surface 24 from the component model 20 illustrated in the example of FIG. 12. The description will be given below with an example where the four surfaces including the surfaces 24, 25, and 26 and the surface facing the surface 24 are extracted by the first specification unit 15b.

Once the four surfaces including the surfaces 24, 25, and 26 and the surface facing the surface 24 have been extracted, the first specification unit 15b generates a bounding box model including the four extracted surfaces, the deformation surface 22, and the back surface 23. In the bounding box model, for example, the four extracted surfaces, the deformation surface 22, and the back surface 23 are brought into contact with outer side surfaces of the model. The bounding box model is used as a model to be deformed. FIG. 13 is a diagram illustrating an example of the bounding box generated by the first specification unit. As illustrated in the example of FIG. 13, the first specification unit 15b generates a bounding box model 27 including the six surfaces of the deformation surface 22, the back surface 23, the surfaces 24, 25, and 26, and the surface facing the surface 24. The description will be given below with an example where the bounding box model 27 is generated by the first specification unit 15b.

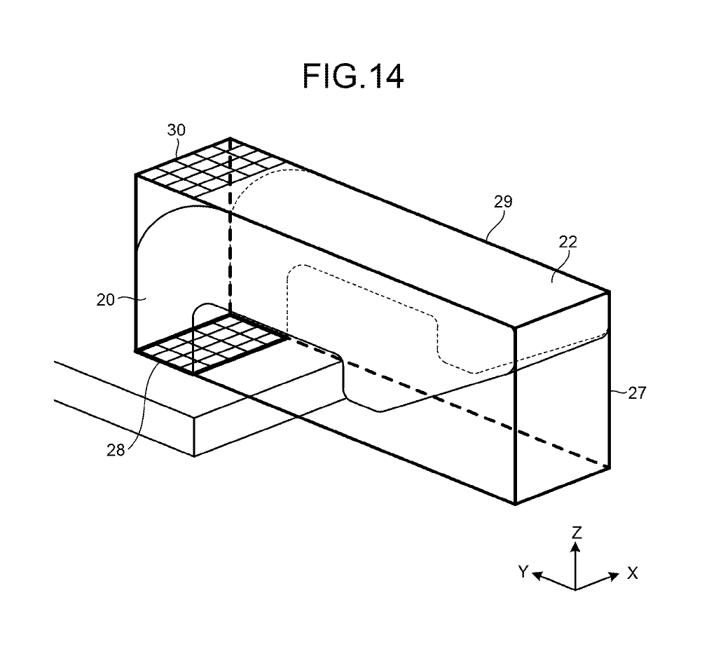

Now, the first specification unit 15b specifies the interference region in which the surface of the bounding box model 27 interferes with the component model 20. FIG. 14 is a diagram for describing an example of a process performed by the calculation apparatus according to Example. In the example of FIG. 14, the surface of the bounding box model 27 interferes with the component model 20 in a interference region 28. In the example of FIG. 14, the first specification unit 15b specifies the interference region 28 as the region in which the surface of the bounding box model 27 interferes with the component model 20.

Here, the interference region is a fixed surface when the bounding box model 27 to be deformed is deformed. Thus, there would be a plurality of the fixed surfaces present when a plurality of the interference regions are specified, thereby causing a possibility that the bounding box model 27 would be fixed and not deformed. Now, when the plurality of interference regions are specified, the first specification unit 15b expands the bounding box model so as to include a surface connected to the surface of the component model having the edge of the interference regions. The first specification unit 15b then re-specifies the interference region in which the surface of the bounding box model after expansion interferes with the component model. The first specification unit 15b repeats such process until there remains one interference region specified. Described hereinafter is a case where the interference region 28 is specified by the first specification unit 15b.

Next, the first specification unit 15b projects the specified interference region 28 onto a surface 29 in contact with the deformation surface 22 among the surfaces of the bounding box model 27 and specifies the region of the surface 29 onto which the interference region has been projected as the fixed surface region. As illustrated in the example of FIG. 14, the first specification unit 15b specifies a region 30 of the surface 29 onto which the interference region 28 has been projected as the fixed surface region.

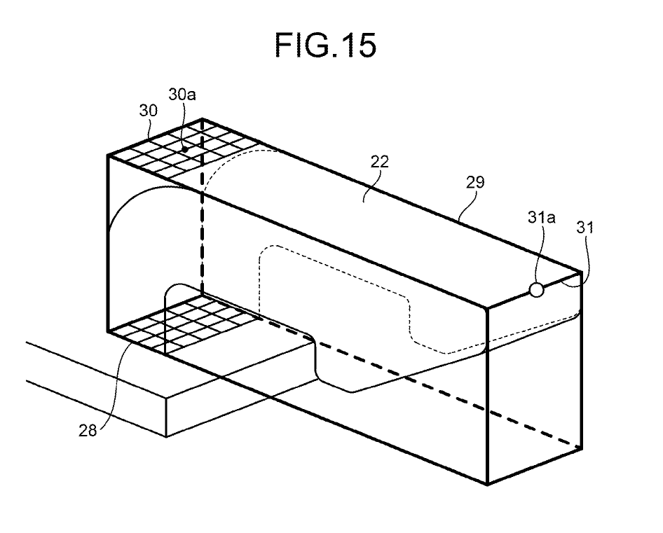

The second specification unit 15c specifies a displacement point for deforming the bounding box model 27 on the basis of the position of the fixed surface region of the surface 29 onto which the interference region 28 specified by the first specification unit 15b is projected, the position being located on the bounding box model 27. FIG. 15 is a diagram for describing an example of a process performed by the calculation apparatus according to Example. For example, as illustrated in the example of FIG. 15, the second specification unit 15c specifies a center point of a side 31 as the displacement point 31a, the side 31 being farthest away from a predetermined point such as a center point 30a of the specified fixed surface region 30 among the sides of the surface 29.

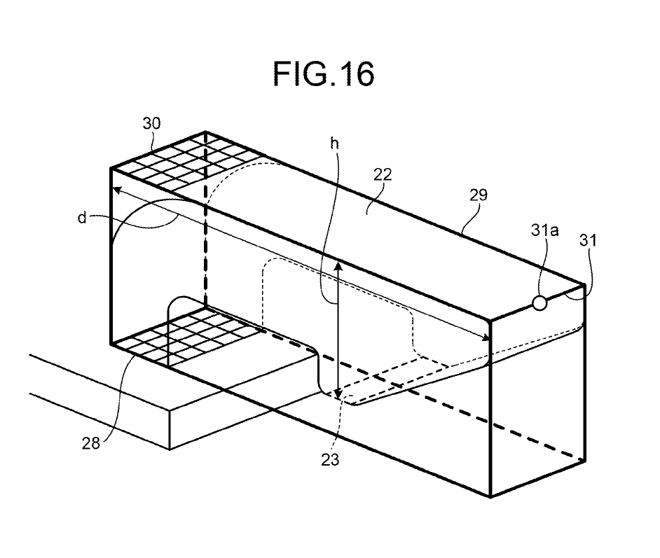

The first calculation unit 15d performs the following process on the basis of: a distance from a predetermined position in the fixed surface region 30 on the surface 29 of the bounding box model 27 that is in contact with the deformation surface 22 to the displacement point 31a; and a distance from the deformation surface 22 to the back surface 23 facing the deformation surface 22. That is, the first calculation unit 15d calculates a physical property value related to the deformation of the component model 20. FIG. 16 is a diagram for describing an example of a process performed by the calculation apparatus according to Example. The example in FIG. 16 illustrates a case where a distance on the Y-axis from the maximum Y-coordinate value point in the fixed surface region 30 to the displacement point 31a is represented by “d”. The example in FIG. 16 also illustrates a case where a distance from the deformation surface 22 to the back surface 23 is represented by “h”. In the example of FIG. 16, the first calculation unit 15d calculates a physical property value K obtained by an expression ((h/d)×α) indicating the difficulty for the component model 20 to undergo deformation. Here, a denotes a predetermined coefficient.

The second calculation unit 15e performs the following process on the basis of the physical property value K and the position after deformation of the component model 20 that is designated by the user. That is, the second calculation unit 15e calculates an attitude of the bounding box model 27 in the case where the bounding box model 27 is deformed such that the position of the displacement point 31a would be the position of the designated component model 20 after deformation.

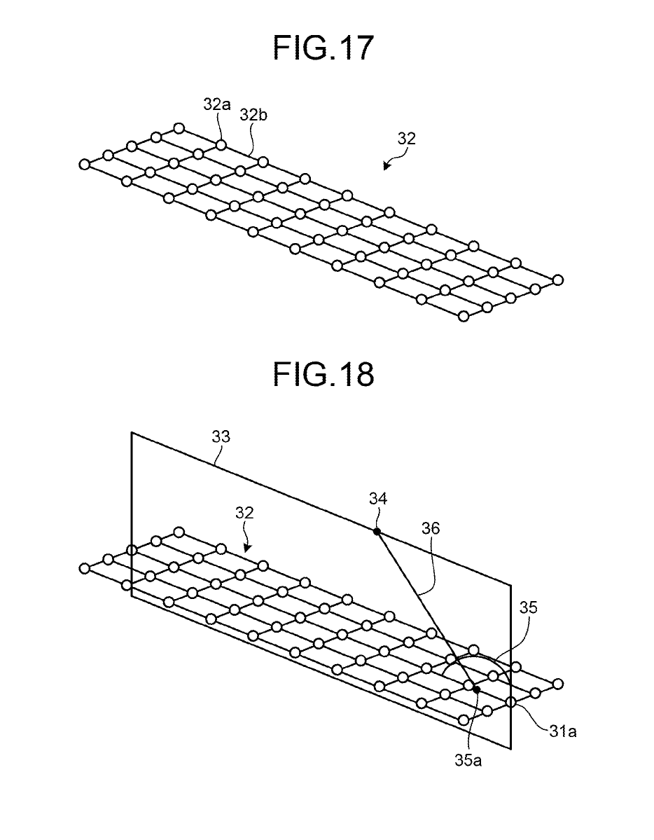

A specific example will be given below. FIG. 17 is a diagram for describing an example of a process performed by the calculation apparatus according to Example. As illustrated in the example of FIG. 17, the second calculation unit 15e generates a two-dimensional spring-mass system model (a plane model) 32 of the surface 29 of the bounding box model 27 in contact with the deformation surface 22. This plane model 32 will be noted as a “deformation standard model” in the description below. As illustrated in the example of FIG. 17, the deformation standard model 32 includes a plurality of mass points 32a and springs 32b connecting the mass points 32a arranged in a grid pattern. For example, the deformation standard model 32 is what is called a spring-mass model. A pitch interval of the mass point 32a is determined on the basis of the physical property value K.

The second calculation unit 15e deforms the deformation standard model 32. FIG. 18 is a diagram for describing an example of a process performed by the calculation apparatus according to Example. For example, as illustrated in the example of FIG. 18, the second calculation unit 15e first projects a point of the three-dimensional coordinates (x, y, z) indicating the position after deformation of the component model 20 that is designated by the user onto an X plane (a Y-Z plane) 33 that passes through the displacement point 31a. In the example of FIG. 18, such point projected onto the X plane 33 is a point 34. The second calculation unit 15e also generates on the X plane 33 a circle 35 that passes through the displacement point 31a and has the radius equal to the physical property value K. Then, the second calculation unit 15e generates a line segment 36 on the X plane 33 to connect a center 35a of the circle 35 and the point 34.

After that, the second calculation unit 15e deforms the deformation standard model 32 such that the position of the displacement point 31a would be in the position of the point 34. At this time, the second calculation unit 15e deforms the deformation standard model 32 so that the shape of the deformed deformation standard model 32 would be brought into contact with the line segment 36.

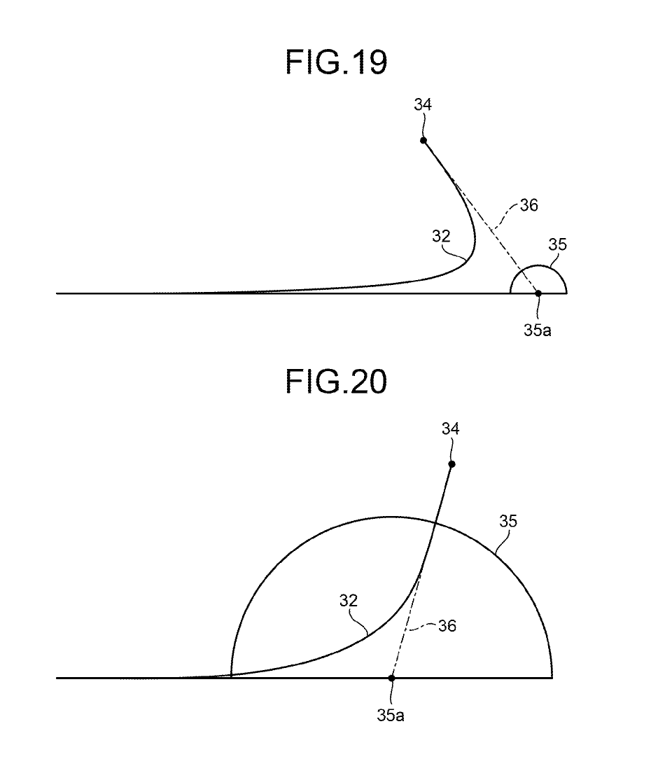

FIGS. 19 and 20 are diagrams for describing that the shape of the deformation standard model would be different when deformed depending on the magnitude of the physical property value K. The magnitude of the physical property value K in the example of FIG. 19 is smaller than the magnitude of the physical property value K in the example of FIG. 20. That is, the deformation standard model 32 in the example of FIG. 19 is more prone to deformation than the deformation standard model 32 in the example of FIG. 20. Here, the radius of the circle 35 in the example of FIG. 19 is smaller than the radius of the circle 35 in the example of FIG. 20, whereby the deformation standard model 32 illustrated in the example of FIG. 19 would experience a greater degree of deformation than the deformation standard model 32 illustrated in the example of FIG. 20.

Then, the second calculation unit 15e calculates the attitude of each surface of the deformation standard model 32 after deformation. Here, the attitude represents how much each surface is rotated about each axis of the X-axis, the Y-axis and the Z-axis from a reference surface, and is represented by the degree of rotation.

As heretofore mentioned, the first specification unit 15b specifies the interference region 28 in which the component model 20 interferes with the bounding box model 27, the outer side surface of which is in contact with the deformation surface 22 of the component model 20. The second specification unit 15c specifies the displacement point 31a for the deformation of the bounding box model 27 on the basis of the position of the fixed surface region 30 of the surface 29 onto which the interference region 28 specified by the first specification unit 15b is projected, the position being located on the bounding box model 27. Subsequently, the first calculation unit 15d performs the following process on the basis of: the distance d from the predetermined position in the fixed surface region 30 on the surface 29 of the bounding box model 27 that is in contact with the deformation surface 22 to the displacement point 31a; and the distance h from the deformation surface 22 to the back surface 23 facing the deformation surface 22. That is, the first calculation unit 15d calculates the physical property value K related to the deformation of the component model 20 and obtained by the expression ((h/d)×α). After that, the second calculation unit 15e performs the following process on the basis of the physical property value K and the position after deformation of the component model 20 that is designated by the user. That is, the second calculation unit 15e calculates the attitude of the bounding box model 27 in the case where the bounding box model 27 is deformed such that the position of the displacement point 31a would be in the position of the designated component model 20 after deformation. In this manner, the calculation apparatus 10 according to the present Example calculates the physical property value of the component model 20 and the attitude of the bounding box model 27 by using the physical property value calculated. Therefore, the information related to the component model 20 after deformation can be easily obtained by the calculation apparatus 10 according to the present Example.

Moreover, the second calculation unit 15e performs the following process with the region of the surface 29 onto which the interference region 28 is projected serving as the fixed surface region 30 when deforming the bounding box model 27. That is, the second calculation unit 15e calculates the attitude of the bounding box model 27 in the case where the bounding box model 27 is deformed such that the position of the displacement point 31a would be in the position of the component model 20 after deformation. In this way, the calculation apparatus 10 according to the present Example calculates the attitude of the bounding box model 27 without setting a boundary condition such as the fixed surface by the user. Therefore, the information related to the component model 20 after deformation can be easily obtained by the calculation apparatus 10 according to the present Example.

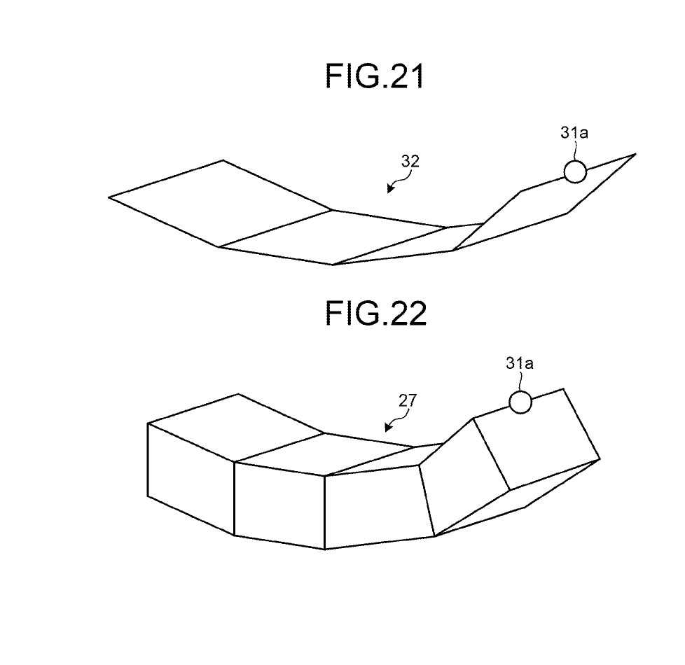

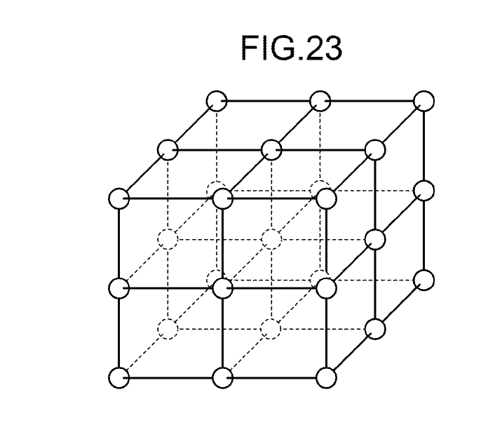

The generation unit 15f generates the CAD data representing the bounding box model 27 in the case where the bounding box model 27 is deformed to have the attitude calculated by the second calculation unit 15e. A specific example will be given below. FIG. 21 is a diagram illustrating an example of the shape of the deformation standard model after deformation, and FIG. 22 is a diagram illustrating an example of a case where the bounding box model is deformed. The second calculation unit 15e performs the following process along the shape of the deformation standard model 32 after deformation, as illustrated in the example of FIG. 21, by means of FFD (Free-Form Deformation). That is, as illustrated in the example of FIG. 22, the second calculation unit 15e deforms the bounding box model 27, generates the CAD data for the bounding box model 27 after deformation and stores it in the storage unit 14. The FFD will be described. FIG. 23 is a diagram for describing the FFD. As illustrated in the example of FIG. 23, in the FFD, a group of control grid points is generated by equally dividing a rectangular parallelepiped containing a substance therein to set space surrounded by the group of control grid points. In the FFD, the space is distorted by moving the group of control grid points, accompanied by the deformation of the substance.

The generation unit 15f then records the information related to the deformation when the designated instruction is the deformation instruction. Specifically, for example, the generation unit 15f adds a new record to the aforementioned animation information 14b. Then, the generation unit 15f registers, under the item “timeline”, the order in which the animation is to be reproduced. In addition, the generation unit 15f registers an ID of the component model 20 under the item “target model”. Moreover, the generation unit 15f registers, under the item “move/deformation”, a value such as “1” indicating the reproduction of the animation in which the component model 20 is deformed. Furthermore, the generation unit 15f registers, under the item “displacement data”, an ID for identifying the data related to the deformation of the component model 20.

Next, the generation unit 15f adds a new record to the aforementioned deformation information 14c. The generation unit 15f then registers, under the item “deformation displacement data” for the new record, an ID identical to the ID registered under the item “displacement data”, whereby the animation information 14b and the deformation information 14c would be associated with each other. In addition, the generation unit 15f registers, under the item “surface ID”, the ID of the surface 22 to be deformed, the surface being designated by the operation of the input unit 11 by the user. Moreover, the generation unit 15f sets a value indicating that the component model 20 is to be deformed under the item “deformation/cancellation”, when the component model 20 is to be deformed. When the instruction to cancel the deformation of the component model is input, the generation unit 15f can also set a value indicating that the deformation of the component model 20 is to be cancelled under the item “deformation/cancellation”. Moreover, the generation unit 15f registers, under the item “target position”, the three-dimensional coordinates indicating the position of the component model 20 after deformation, the three-dimensional coordinates being designated by the operation of the input unit 11 by the user. Furthermore, the generation unit 15f registers, under the item “relative attitude (Rx, Ry, Rz)”, the amount indicating the variation in the attitude of the surface 22 after deformation with respect to the attitude before deformation when the component model 20 is deformed, the surface 22 being indicated by the ID registered under the “surface ID”.

Furthermore, when the move instruction is designated by the user, the generation unit 15f moves the component model to be moved designated by the user on the basis of the rotation instruction, the translation instruction, the axis of rotation, the degree of rotation, the move amount, and the like that are designated on the instruction acceptance screen.

The generation unit 15f then records the information related to movement when the designated instruction is the move instruction. Specifically, for example, the generation unit 15f adds a new record to the aforementioned animation information 14b. Then, the generation unit 15f registers, under the item “timeline”, the order in which the animation is to be reproduced. In addition, the generation unit 15f registers the ID of the component model under the item “target model”. Moreover, the generation unit 15f registers, under the item “move/deformation”, a value such as “0” indicating the reproduction of the animation in which the component model is moved. Furthermore, the generation unit 15f registers, under the item “displacement data”, an ID for identifying the data related to the move of the component model 20.

Next, the generation unit 15f adds a new record to the aforementioned move information 14d. The generation unit 15f then registers, under the item “move displacement data” for the new record, an ID identical to the ID registered under the item “displacement data”, whereby the animation information 14b and the move information 14d would be associated with each other. Moreover, the generation unit 15f registers, under the item “relative position (x, y, z)”, information indicating how much the position of the component model has been moved from the position of the component model before move. Furthermore, the generation unit 15f registers, under the item “relative attitude (Rx, Ry, Rz)”, the amount indicating the variation in the attitude of the component model after deformation with respect to the attitude before deformation when the component model is deformed.

The reproduction unit 15g reproduces the animation. For example, the reproduction unit 15g performs the following process when the instruction to reproduce the animation is input by the input unit 11. That is, the reproduction unit 15g acquires the displacement data of the model indicated by the ID registered under the item “target model” from the deformation information 14c or the move information 14d corresponding to the value registered under the item “move/deformation”, with the ID registered under the item “displacement data” serving as the key. The reproduction unit 15g then displays the animation indicated by the acquired displacement data on the display unit 12. The reproduction unit 15g performs such process in the order registered under the item “timeline” of the animation information 14b.

The control unit 15 is an integrated circuit such as an ASIC (Application Specific Integrated Circuit) and an FPGA (Field Programmable Gate Array) or an electronic circuit such as a CPU (Central Processing Unit) and an MPU (Micro Processing Unit).

Process Flow

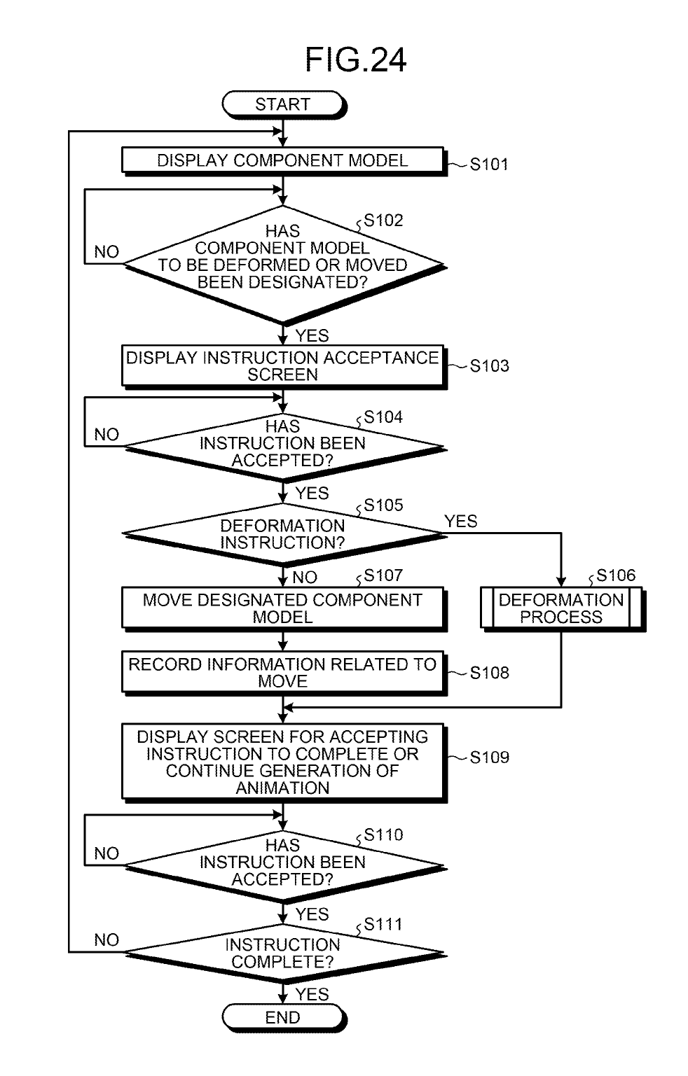

Now, a process flow of the calculation apparatus 10 according to the present Example will be described. FIG. 24 is a flowchart illustrating steps of a calculation process according to Example. For example, the calculation process is performed at a timing at which the control unit 15 has accepted an instruction to perform the calculation process from the input unit 11.

As illustrated in FIG. 24, the acquisition unit 15a acquires the CAD data 14a from the storage unit 14 and controls the display on the display unit 12 such that the plurality of component models of the product represented by the acquired CAD data 14a is displayed (S101). Next, the acquisition unit 15a determines whether or not the user has designated the component model to be deformed or moved by operating the input unit 11 (S102).

When the component model to be deformed or moved has not been designated (No in S102), the acquisition unit 15a repeats the determination in S102. On the other hand, the acquisition unit 15a performs the following process when the component model to be deformed or moved has been designated (Yes in S102). That is, the acquisition unit 15a controls the display on the display unit 12 in order to display the instruction acceptance screen for accepting the move instruction for moving the component model to be moved, and the deformation instruction for deforming the component model to be deformed (S103).

Next, the acquisition unit 15a determines whether or not the move instruction or the deformation instruction has been accepted (S104). When the move instruction or the deformation instruction has not been accepted (No in S104), the acquisition unit 15a repeats the determination in S104. When the move instruction or the deformation instruction has been accepted (Yes in S104), on the other hand, the acquisition unit 15a determines whether or not the accepted instruction is the deformation instruction (S105).

When the accepted instruction is the deformation instruction (Yes in S105), the control unit 15 performs a deformation process to be described (S106) and proceeds to S109. When the accepted instruction is not deformation instruction, that is, when the accepted instruction is the move instruction (No in S105), the generation unit 15f performs the following process. That is, the generation unit 15f moves the component model to be moved designated by the user, on the basis of the rotation instruction, the translation instruction, the axis of rotation, the degree of rotation, the move amount and the like that are designated on the instruction acceptance screen (S107). The generation unit 15f then records the information related to the aforementioned move (S108). Thereafter, the acquisition unit 15a controls the display on the display unit 12 in order to display the screen for accepting the instruction to complete or continue the generation of the animation (S109).

Next, the acquisition unit 15a determines whether or not the instruction to complete or continue the generation of the animation has been accepted (S110). When neither the instruction to complete nor the instruction to continue the generation of the animation has been accepted (No in S110), the acquisition unit 15a repeats the determination in S110. On the other hand, when the instruction to complete or continue the generation of the animation has been accepted (Yes in S110), the acquisition unit 15a determines whether or not the accepted instruction is to complete the generation of the animation (S111). When the accepted instruction is not to complete the generation of the animation, that is, when the accepted instruction is to continue generating the animation (No in S111), the process goes back to S101. On the other hand, the process will be complete when the accepted instruction is to complete the generation of the animation (Yes in S111).

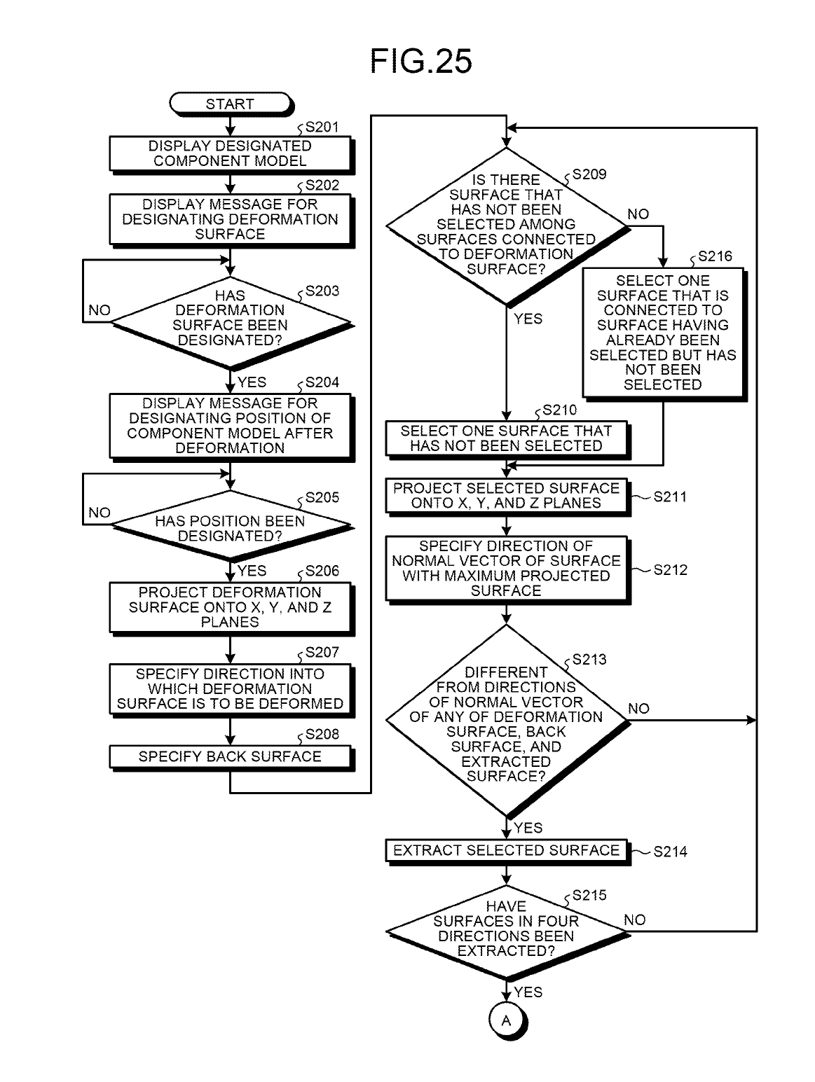

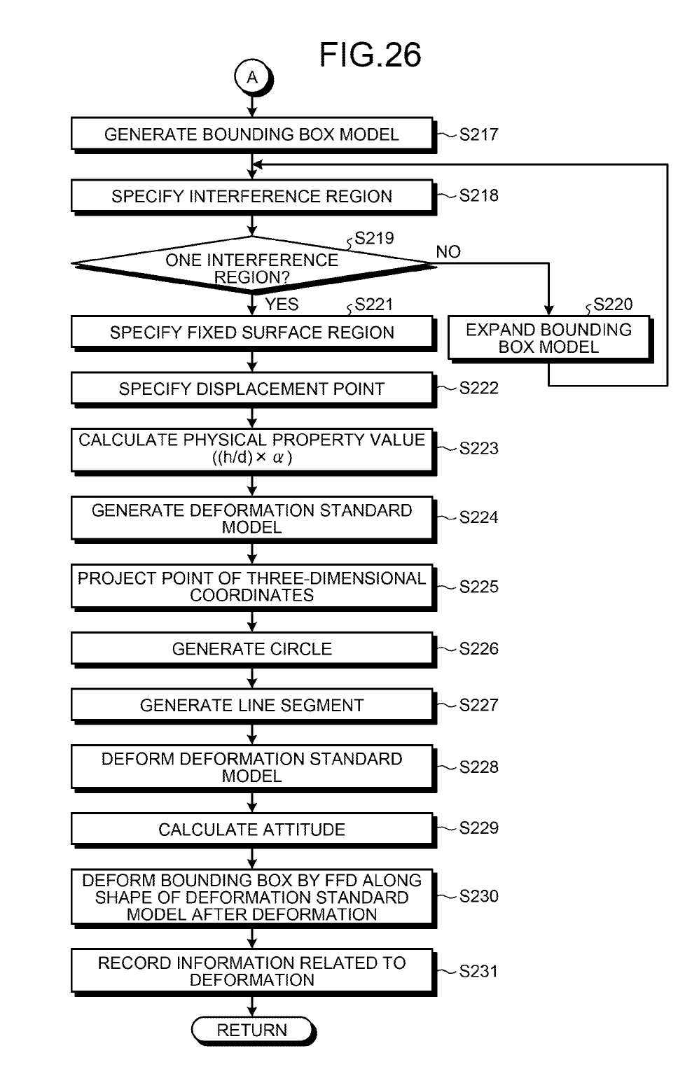

Now, the deformation process will be described. FIGS. 25 and 26 are flowcharts illustrating steps of the deformation process according to Example. As illustrated in FIG. 25, the first specification unit 15b controls the display on the display unit 12 such that the component model for which the deformation instruction has been designated is displayed (S201).

The first specification unit 15b then controls the display on the display unit 12 in order to display the message for designating the surface to be deformed (the deformation surface) among each of the surfaces of the component model for which the deformation instruction has been designated (S202). Next, the first specification unit 15b determines whether or not the deformation surface has been designated by the user (S203). When the user has not designated the deformation surface (No in S203), the first specification unit 15b repeats the determination in S203.

On the other hand, when the user has designated the deformation surface (Yes in S203), the first specification unit 15b performs the following process. That is, the first specification unit 15b controls the display on the display unit 12 in order to display the message for designating the three-dimensional coordinates (x, y, z) indicating the position of the designated component model after deformation (S204).

Next, the first specification unit 15b determines whether or not the three-dimensional coordinates (x, y, z) indicating the position of the component model after deformation have been designated by the user (S205). When the user has not designated the three-dimensional coordinates (x, y, z) indicating the position of the component model after deformation (No in S205), the first specification unit 15b repeats the determination in S205. On the other hand, when the user has designated the three-dimensional coordinates (x, y, z) indicating the position of the component model after deformation (Yes in S205), the first specification unit 15b projects the deformation surface 22 onto each of the X plane, the Y plane, and the Z plane (S206).

Next, the first specification unit 15b specifies one region having the maximum area among the regions of the deformation surface 22 projected onto each of the X plane, the Y plane, and the Z plane, and specifies the direction of the normal vector of the plane onto which the specified region has been projected as the direction into which the deformation surface is to be deformed (S207).

Next, the first specification unit 15b searches for the surface of the component model that is present in the direction opposite from the specified direction of the normal vector, and specifies the surface farthest away from the deformation surface as the surface on the back side of the deformation surface (the back surface) (S208).

Next, the first specification unit 15b determines whether or not there is a surface that has not been selected among the surfaces connected to the deformation surface (S209). When there is the surface that has not been selected (Yes in S209), the first specification unit 15b selects one surface that has not been selected among the surfaces connected to the deformation surface (S210). When there is no surface that has not been selected (No in S209), the first specification unit 15b selects one surface that is connected to the surface having already been selected but that has not been selected (S216). Then, the first specification unit 15b projects the selected surface onto each of the X plane, the Y plane, and the Z plane (S211). The first specification unit 15b then specifies the direction of the normal vector of the plane onto which the region with the maximum area is projected among the regions of the surface that is projected onto each of the X plane, the Y plane, and the Z plane (S212). Then, the first specification unit 15b determines whether or not the specified direction of the normal vector is in the following direction. That is, the first specification unit 15b determines whether or not the direction of the normal vector is different from any of: the direction into which the deformation surface 22 is to be deformed; the direction of the normal vector of the back surface 23; and the direction of the normal vector of the extracted surface when the surface is extracted in S212 below (S213).

When the direction of the normal vector coincides with any one of the directions (No in S213), the process goes back to S209. When the direction of the normal vector is different from any of the directions (Yes in S213), the first specification unit 15b extracts the selected surface (S214). Then, the first specification unit 15b determines whether or not four surfaces have been extracted, the four surfaces having the normal vectors in four directions other than the direction into which the deformation surface is to be deformed and the direction of the normal vector of the back surface, among six directions including a positive and a negative directions for each of the X, the Y, and the Z axes (S215). When the four surfaces have not been extracted (No in S215), the process goes back to S209.

On the other hand, when the four surfaces have been extracted (Yes in S215), the first specification unit 15b generates the bounding box model including the four extracted surfaces, the deformation surface, and the back surface (S217).

Next, the first specification unit 15b specifies the interference region in which the surface of the bounding box model interferes with the component model (S218). The first specification unit 15b then determines whether or not one interference region has been specified (S219). When the number of the interference region specified is not one, that is, when the plurality of interference regions is specified (No in S219), the first specification unit 15b performs the following process. That is, the first specification unit 15b expands the bounding box model so as to include the surface connected to the surface of the component model having the edge of the interference regions (S220). The process then goes back to S218, and the first specification unit 15b re-specifies the interference region in which the surface of the bounding box model after expansion interferes with the component model to perform the process that follows.

When one interference region has been specified (Yes in S219), on the other hand, the first specification unit 15b projects the interference region onto the surface in contact with the deformation surface among the surfaces of the bounding box model and specifies the region of the surface, which is in contact with the deformation surface and onto which the interference region has been projected, as the fixed surface region (S221).

Subsequently, the second specification unit 15c specifies the center point of the side as the displacement point, the side being farthest away from the predetermined point of the specified fixed surface region among the sides of the surface onto which the interference region has been projected (S222).

Then, the first calculation unit 15d calculates the physical property value K related to the deformation of the component model and obtained by the expression ((h/d)×α), on the basis of the distance “d” from a predetermined position in the fixed surface region to the displacement point and the distance “h” from the deformation surface to the back surface facing the deformation surface (S223).

Thereafter, the second calculation unit 15e performs the following process on the basis of the physical property value K and the position after deformation of the component model that is designated by the user. That is, the second calculation unit 15e calculates the attitude of the bounding box model 27 in the case where the bounding box model is deformed such that the position of the displacement point would be in the position of the designated component model after deformation (S224).

Then, the second calculation unit 15e projects the point of the three-dimensional coordinates (x, y, z) indicating the position after deformation of the component model that is designated by the user, onto any of the X plane, the Y plane, and the Z plane passing through the displacement point (S225). The second calculation unit 15e then generates on such plane the circle that passes through the displacement point and has the radius equal to the physical property value K (S226). Then, the second calculation unit 15e generates the line segment on the plane to connect the center of the circle and the projected point (S227).

After that, the second calculation unit 15e deforms the deformation standard model such that the position of the displacement point of the deformation standard model would be in the position of the point that is projected onto the plane. At this time, the second calculation unit 15e deforms the deformation standard model so that the shape of the deformed deformation standard model would be brought into contact with the line segment (S228). The second calculation unit 15e then calculates the attitude of each surface of the deformation standard model after deformation (S229).

Next, the second calculation unit 15e deforms, by means of the FFD, the bounding box model along the shape of the deformation standard model after deformation, generates the CAD data for the bounding box model after deformation and stores it in the storage unit 14 (S230).

Then, the generation unit 15f records the aforementioned information related to the deformation (S231), stores the process result in the internal memory, and returns.

As heretofore mentioned, the calculation apparatus 10 according to the present Example specifies the interference region 28 in which the component model 20 interferes with the bounding box model 27, the outer side surface of which is in contact with the deformation surface 22 of the component model 20. The calculation apparatus 10 specifies the displacement point 31a for the deformation of the bounding box model 27 on the basis of the position of the fixed surface region 30 of the surface 29 onto which the specified interference region 28 is projected, the position being located on the bounding box model 27. Subsequently, the calculation apparatus 10 performs the following process on the basis of: the distance d from the predetermined position in the fixed surface region 30 on the surface 29 of the bounding box model 27 that is in contact with the deformation surface 22 to the displacement point 31a; and the distance h from the deformation surface 22 to the back surface 23 facing the deformation surface 22. That is, the calculation apparatus 10 calculates the physical property value K related to the deformation of the component model 20 and obtained by the expression ((h/d)×α). After that, the calculation apparatus 10 performs the following process on the basis of the physical property value K and the position after deformation of the component model 20 that is designated by the user. That is, the calculation apparatus 10 calculates the attitude of the bounding box model 27 in the case where the bounding box model 27 is deformed such that the position of the displacement point 31a would be in the position of the designated component model 20 after deformation. In this manner, the calculation apparatus 10 according to the present Example calculates the physical property value of the component model 20 and the attitude of the bounding box model 27 by using the physical property value calculated. Therefore, the information related to the component model 20 after deformation can be easily obtained by the calculation apparatus 10 according to the present Example.

Moreover, the calculation apparatus 10 performs the following process with the region of the surface 29 onto which the specified interference region 28 is projected serving as the fixed surface region 30 when deforming the bounding box model 27. That is, the calculation apparatus 10 calculates the attitude of the bounding box model 27 in the case where the bounding box model 27 is deformed such that the position of the displacement point 31a would be in the position of the component model 20 after deformation. In this way, the calculation apparatus 10 according to the present Example calculates the attitude of the bounding box model 27 without setting the boundary condition such as the fixed surface by the user. Therefore, the information related to the component model 20 after deformation can be easily obtained by the calculation apparatus 10 according to the present Example.

Although Example related to the disclosed apparatus has been described, the present invention may also be embodied in various different forms in addition to the aforementioned Example. Now, another Example included in the present invention will be described below.

For example, all or a part of the processes that have been described to be performed automatically, among each of the processes described in Example, can also be performed manually. In addition, all or a part of the processes that have been described to be performed manually, among each of the processes described in Example, can also be performed automatically by a known method.

Moreover, the processes at each step of each of the processes described in each Example can be split into smaller processes or lumped together at will according to various loads, a status of use and the like. The step can also be omitted.

Furthermore, the order of the processes at each step of each of the processes described in each Example can be changed according to the various loads, the status of use and the like.

Furthermore, each constituent element of each unit illustrated is of a functional concept and does not have to be configured physically as illustrated in the figures. That is, a specific state of distribution and/or integration of each unit is not limited to the one illustrated in the figures. All or a part of each of the units can be configured by being functionally or physically distributed and/or integrated by an arbitrary unit according to the various loads, the status of use and the like.

Calculation Program

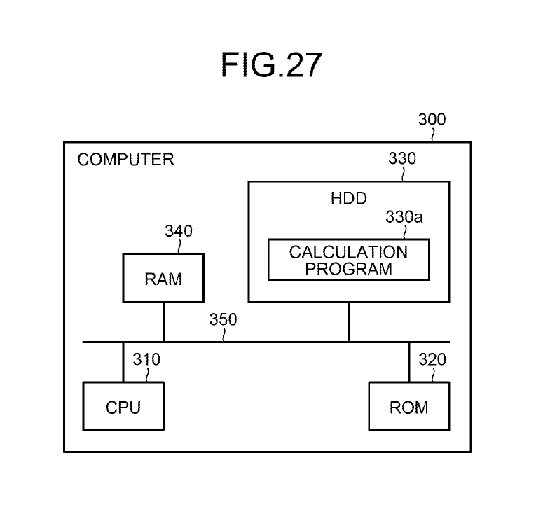

In addition, the various processes of the calculation apparatus 10 described in Example above can also be implemented by executing a program prepared in advance in a computer system such as a personal computer and a workstation. Now, an example of a computer that executes a calculation program having the function similar to that of the calculation apparatus 10 described in Example above will be described below with reference to FIG. 27. FIG. 27 is a diagram illustrating the computer that executes the calculation program.

As illustrated in FIG. 27, a computer 300 includes a CPU 310, a ROM 320, an HDD 330, and a RAM 340. The CPU 310, the ROM 320, the HDD 330, and the RAM 340 are mutually connected via a bus 350.

A basic program such as an OS is stored in the ROM 320. Stored beforehand in the HDD 330 is a calculation program 330a that exerts the function similar to that of the acquisition unit 15a, the first specification unit 15b, the second specification unit 15c, the first calculation unit 15d, the second calculation unit 15e, the generation unit 15f, and the reproduction unit 15g that are illustrated in Example above. The calculation program 330a may also be separated as appropriate. For example, the calculation program 330a can be separated as follows. That is, the calculation program 330a can be separated into three programs including: a program exerting the function similar to that of the acquisition unit 15a; a program exerting the function similar to that of the first specification unit 15b, the second specification unit 15c, the first calculation unit 15d, the second calculation unit 15e, and the generation unit 15f; and a program exerting the function similar to that of the reproduction unit 15g. Moreover, the HDD 330 is provided with CAD data, animation information, deformation information, and move information. These CAD data, the animation information, the deformation information, and the move information correspond to the aforementioned CAD data 14a, the animation information 14b, the deformation information 14c, and the move information 14d.

Then, the CPU 310 reads the calculation program 330a from the HDD 330 and executes it.

The CPU 310 then reads the CAD data, the animation information, the deformation information, the move information and the like and stores them in the RAM 340. Moreover, the CPU 310 executes the calculation program 330a by using the CAD data, the animation information, the deformation information, the move information and the like that are stored in the RAM 340. Note that not all the data have to be stored in the RAM 340 at all times. The data used in the process needs only be stored in the RAM 340.

The aforementioned calculation program 330a does not have to be stored in the HDD 330 from the beginning.

For example, the program can be stored beforehand in a “portable physical medium” such as a flexible disk (FD), a CD-ROM, a DVD disk, a magneto-optical disk, and an IC card that are to be inserted into the computer 300. The computer 300 can then read the program from these media for execution.

Furthermore, the program can be stored beforehand in “another computer (or a server)” or the like that is connected to the computer 300 through a public line, the Internet, a LAN, a WAN or the like. The computer 300 can then read the program from these for execution.

According to one aspect of the calculation apparatus, the calculation program and the calculation method disclosed in the present application, the information related to the model after deformation can be obtained easily.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A calculation apparatus comprising:
a memory; and
a processor coupled to the memory, wherein the processor executes a process comprising:
specifying a region in which a second model including a predetermined surface of a first model interferes with the first model;
specifying a displacement point of the second model when deformed, on the basis of a position in the second model of the region specified;
calculating a physical property value related to deformation of the first model on the basis of a first distance from a predetermined position of the region projected onto a surface of the second model corresponding to the predetermined surface to the displacement point, and a second distance from the predetermined surface to a surface of the first model facing the predetermined surface; and
calculating an attitude of the second model in the case where the second model is deformed such that a position of the displacement point is in a position of the first model after deformation, on the basis of the physical property value calculated and the position of the first model after deformation when deforming the first model.

2. The calculation apparatus according to claim 1, wherein the calculating an attitude includes calculating the attitude of the second model in the case where the second model is deformed such that the position of the displacement point is in the position of the first model after deformation, while treating the projected region as a fixed surface when the second model is to be deformed.

3. The calculation apparatus according to claim 1, wherein the specifying the region includes extracting a surface of the first model facing the predetermined surface, extracts a plurality of surfaces of the first model that are connected to the predetermined surface, generating the second model including the predetermined surface and the extracted surfaces, and specifying the region in which the second model generated interferes with the first model.

4. The calculation apparatus according to claim 1, wherein the specifying the region includes calculating the physical property value by dividing the second distance by the first distance and multiplying a quotient of the division by a predetermined coefficient.

5. The calculation apparatus according to claim 1, the process further comprising generating data representing the second model when the second model is deformed to have the attitude calculated.

6. A computer-readable recording medium having stored therein a calculation program causing a computer to execute a process comprising:
specifying a region in which a second model including a predetermined surface of a first model interferes with the first model;
specifying a displacement point of the second model when deformed on the basis of a position of the specified region in the second model;
calculating a physical property value related to deformation of the first model on the basis of a first distance from a predetermined position of the region projected onto a surface of the second model corresponding to the predetermined surface to the displacement point, and a second distance from the predetermined surface to a surface of the first model facing the predetermined surface; and
calculating an attitude of the second model in the case where the second model is deformed such that a position of the displacement point is in a position of the first model after deformation while treating the projected region as a fixed surface when the second model is to be deformed, on the basis of the calculated physical property value and the position of the first model after deformation when deforming the first model.

7. A calculation method executed by a computer, the calculation method comprising:
specifying a region in which a second model including a predetermined surface of a first model interferes with the first model, using a processor;
specifying a displacement point of the second model when deformed on the basis of a position of the specified region in the second model, using the processor;
calculating a physical property value related to deformation of the first model on the basis of a first distance from a predetermined position of the region projected on a surface of the second model corresponding to the predetermined surface to the displacement point, and a second distance from the predetermined surface to a surface of the first model facing the predetermined surface, using the processor; and
calculating an attitude of the second model in the case where the second model is deformed such that a position of the displacement point is in a position of the first model after deformation while treating the projected region as a fixed surface when the second model is to be deformed, on the basis of the calculated physical property value and the position of the first model after deformation when deforming the first model, using the processor.
